(19) United States
(12) Patent Application Publication
(10) Pub. No.: US 2003/0185497 A1
(43) Pub. Date: Oct. 2, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/295,091

(22) Filed: Nov. 14, 2002

(30) Foreign Application Priority Data
Mar. 29, 2002 (TW) 91204044

(51) Int. Cl. G02B 6/35; G02B 6/32

(52) U.S. Cl. 385/22; 385/33

(57) ABSTRACT

An optical switch (10) for switching light beams from one input optical fiber (101) between a plurality of output optical fibers (201) has a first collimating lens (120) aligning with the input optical fiber and collimating input light beams, a second collimating lens (220) aligning with the output fibers and collimating output light beams; and a switching element (300) between the first and second collimating lens comprising a plurality of optical elements (301). Each optical element can be sequentially moved into an optical axis between the input and output optical fibers, and can deflect the light beams from the input optical fiber in a unique direction, thereby switching the input light beams to different output fibers.

### BACKGROUND OF THE INVENTION

1. Field of the Invention

The present invention relates to an optical switch for using in optical communication and optical network technology, and particularly to a mechanically operated optical switch with a rotatable prism array as a switching element. A copending application having the same filing date, the same title, the same application and the same assignee with the invention, is referenced hereto.

2. Description of Related Art

Optical signals are commonly transmitted in optical fibers, which provide efficient light channels through which optical signals can pass. Recently, optical fibers have been used in various fields, including telecommunications, where light passing through an optical fiber is used to convey either digital or analog information. Efficient switching of optical signals between individual fibers is necessary in most optical processing systems or networks to achieve the desired routing of the signals.

In optical fiber systems, various methods have been previously developed for switching optical signals between fiber cables. Among these previously developed methods, one category is mechanical optical switches.

Mechanically operated optical switches come in two different designs: in one design, the optical components move, and in the other design, the fibers move. Factors for assessing the capability of an optical switch include low insertion loss (<1 dB), good isolation performance (>50 dB) and bandwidth capacity compatible with the fiber network that the switch is supporting.

Moving fiber switches involve the actual physical movement of one or more of the fibers to specific position to accomplish the transmission of a light beam from one fiber end to another under selected switching conditions. Moving optical component switches, on the other hand, include optical collimating lenses which expand the light beam coming from the fibers, and then, using moving prisms or mirrors, redirect the expanded light beam to other fibers, as required by the switching process.

The moving fiber switches have a stringent tolerance requirement for the amount and direction of fiber movement. The tolerance is typically a small fraction of the fiber core diameter for two fibers to precisely collimate to reduce losses. The fibers themselves are quite thin and may be subject to breakage of not properly protected. On the other hand, reinforcing the fibers with stiff protective sheaths makes the fibers less flexible, increasing the force required to manipulate each fiber into alignment. Thus these moving fiber switches share a common problem of requiring high precision parts to obtain precise position control and low insertion loss. This results in high cost and complicated manufacture of the switches. Moreover, frequently moving fibers to and fro is apt to damage or even break the fibers.

The moving optical component switches, in contrast, have less stringent movement control tolerance requirements. The presence of collimating lenses allows relaxation of the tolerance requirements.

As illustrated in FIG. 6, U.S. Pat. No. 5,420,946, describes an optical coupling switch for coupling light beams into a selected output collimator 620. The input fiber 611 is optically aligned with one of a plurality of output fibers 621 via a reflector 630. By rotating the reflector 630 about an axis, the input light beam can be reflected to a selected output fiber 621. The input fiber 611 and all the output fibers 621 are in fixed position relative to each other.

In this mechanical switch, the plurality of output fibers 621 are separately mounted on a platform 600, which makes the structure of the switch complex, the size large and the process of aligning of the input fiber 611 with the plurality of output fibers 621 much more difficult. In addition, this mechanical switch uses a plurality of GRIN lenses (622, 612) on front ends of the output fiber 621 and the input fibers 611 to collimate the light beams, which adds greatly to the cost of the mechanical switch greatly.

For the above reasons, an improved optical switch is desired. In particularly, an optical switch is desired which has low cost, high optical efficiency and which does not require precise alignment or movement of the optical fibers themselves.

### SUMMARY OF THE INVENTION

An object of the present invention is to provide an optical switch in which the optical fibers don't move.

Another object of the present invention is to provide an optical switch which allows easy alignment of associated fibers.

Yet another object of the present invention is to provide an optical switch which has low cost and small size.

An optical switch in accordance with one embodiment of the present invention, for switching light beams from one input optical fiber between a plurality of output optical fibers, has a first collimator aligning with the input optical fiber and collimating input light beams, a second collimator aligning with the output fibers and collimating output light beams; and a switching element between the first and second collimators comprising a plurality of optical prisms. Each optical prism can be moved sequentially into the optical path between the input and output optical fibers, and can thereby deflect the light beams from the input optical fiber in different directions, thereby switching the input light beams to different output fibers.

### BRIEF DISCRIPTION OF THE DRAWINGS

FIG. 1 is a perspective view of an optical switch according to the present invention;

FIG. 2 is a cross-sectional view taken along the line 2-2 in FIG. 1;

FIG. 3 is a cross-sectional view taken along the line 3-3 in FIG. 1;

FIG. 4 is an essential optical paths diagram of the optical switch in FIG. 1 with a first prism in the optical path;

FIG. 5 is an essential optical paths diagram of the optical switch in FIG. 1 with a second prism in the optical path;

FIG. 6 is a perspective view of a prior art mechanical optical switch;

### DETAILED DISCLOSURE OF THE INVENTION

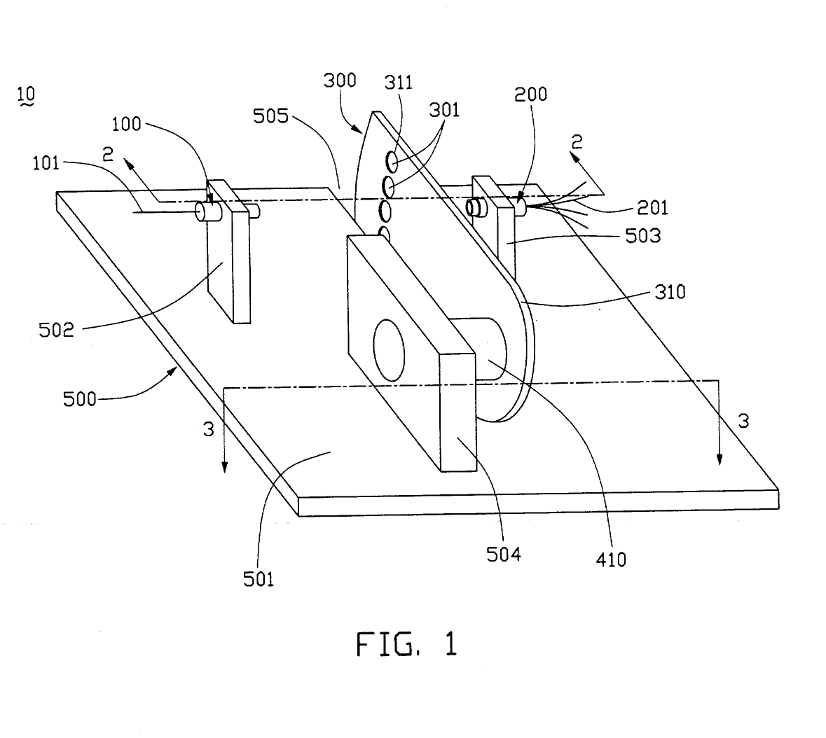

Referring to FIG. 1, an optical switch 10 according to the present invention is used to switch light beams between one input optical fiber 101 and a plurality of output optical fibers 201. The optical switch 10 comprises an input collimator 100 for collimating input light signals, an output collimator 200 for decollimating and outputting the light beams, a switching device 300 for switching the input light signals between a plurality of output fibers 201, and a base 500 for mounting the input collimator 100, the output collimator 200 and the switching device 300 thereon.

The base 500 has a substrate 501 and three upright beams 502, 503, 504 extending upwardly from the substrate 501, and defines an opening 505 between two of the upright beams 502, 503. The upright beams 502, 503 are arranged opposite each other for coaxial alignment of the input collimator 100 with the output collimator 200.

The input collimator 100 comprises a ferrule 110, a molded lens 120 aligning with the ferrule 110, and a quartz sleeve 130 holding the molded lens 120 and the ferrule 110 in fixed relation with one another. The ferrule 110 defines a through hole 111 along a longitudinal axis thereof, which accommodates the input optical fiber 101 therein. The input optical fiber 101 is fixed in the through hole 111 with epoxy resin. The molded lens 120 has a single index of refraction and partially extends out of the quartz sleeve 130. The input collimator 100 further has a metal tube 140 surrounding the quartz sleeve 130 for protecting the input collimator 100.

The output collimator 200 has a structure similar to that of the input collimator 100 but includes a ferrule 210 with a through hole 211 accommodating and fixing a plurality of output optical fibers 201 therein. The output collimator 200 has a molded lens 220 with a single index, which aligns with the ferrule 210, and a quartz sleeve 230 holding the ferrule 210 and the molded lens 220 in fixed relation with one another. The molded lens 220 partially extends out of the quartz sleeve 230. A central axis of the through hole 111 of the input collimator 100 is collinear with a central axis of the through hole 211 of the output collimator 200, and these two central axis are coincident with an optical axis of the optical switch 10.

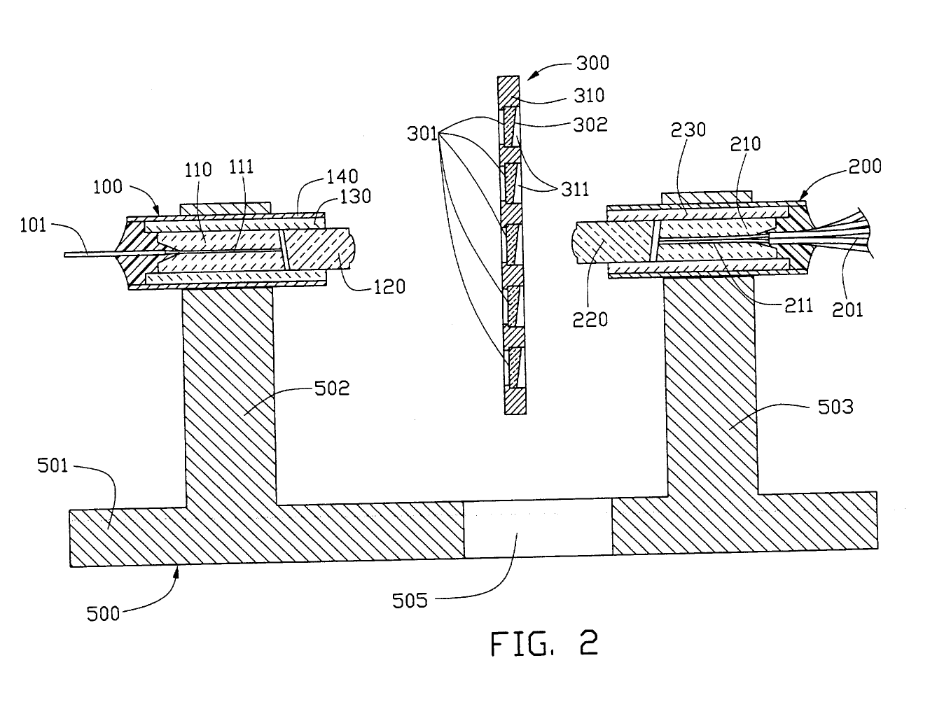

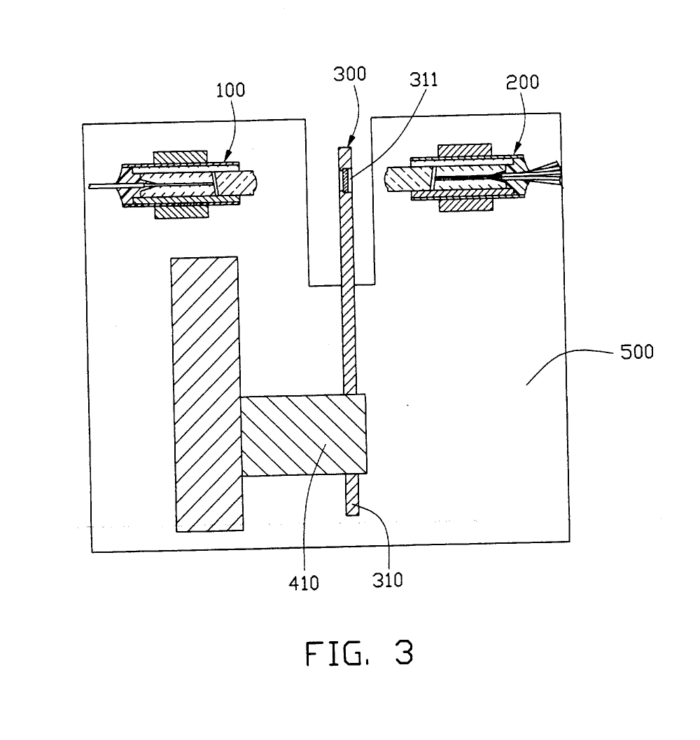

As shown in FIG. 2, the switching device 300 comprises an elongate holder 310 and an array of prisms 301. The holder 310 defines a plurality of mounting holes 311 therethrough arranged in an arc described across a distal end of the holder 310. Each prism of the prism array 301 is fixed in a different mounting hole 311 by epoxy resin. Each prism has an end face 302 at each of two opposite sides. A plane of one end face 302 forms a predetermined angle relative to an imaginary plane constructed perpendicular to the optical axis (not labeled) of the optical switch 10. Each prism 301 can instead be a lens.

The optical switch 10 further includes a driving pole 410 connected with a driver at side of the optical switch 10 to drive the switching device 300 to rotate. The driving pole 410 connects to a proximal end of the end of the holder 310.

In assembly, the input collimator 100, the output collimator 200 and the driving pole 410 are mounted on the upright beams 502, 503, 504, respectively. The holder 310 of the switching device 300 is fixed to the driving pole 410 and is mounted to be rotatably moveable into and out of the opening 505 between the two input and output collimators 100, 200. In this arrangement, each prism in the array of prisms 301 aligns sequentially with the optical axis between the input and output collimators 100, 200. The holder 310 is moved upwardly and downwardly and into the opening 505.

When the driving pole 410 is actuated to rotate, the switching device 300 is driven to rotate, whereby each prism of the prism array 301 is sequentially located in alignment with the input and output collimators 100, 200, respectively, and is intersected by the optical axis. Since each prism of the prism array 301 has an end face 302 which forms a different predetermined angle with an imaginary plane constructed perpendicular to the optical axis of the optical switch 10, then the pair of end surfaces 302 of each different prism will bend signal beams coming from the input collimator 100 in a different direction. Thus, by proper selection of the prism material, the relative angles between end surfaces 302 of one prism, and the position of a given prism in a given mounting hole 311, the angle at which the incoming signals from the input collimator 100 will bend with reference to the optical axis (not labeled) of the optical switch 10 can be predetermined. Each prism, therefore, can divert the incoming signals to a unique predetermined output optical fiber 201. So, the input light beams are switched into different output fibers 201.

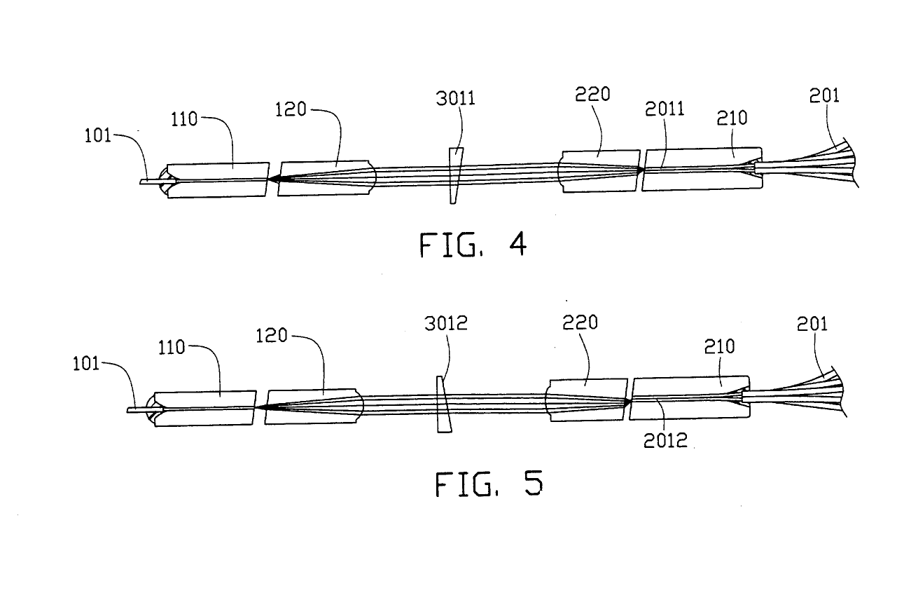

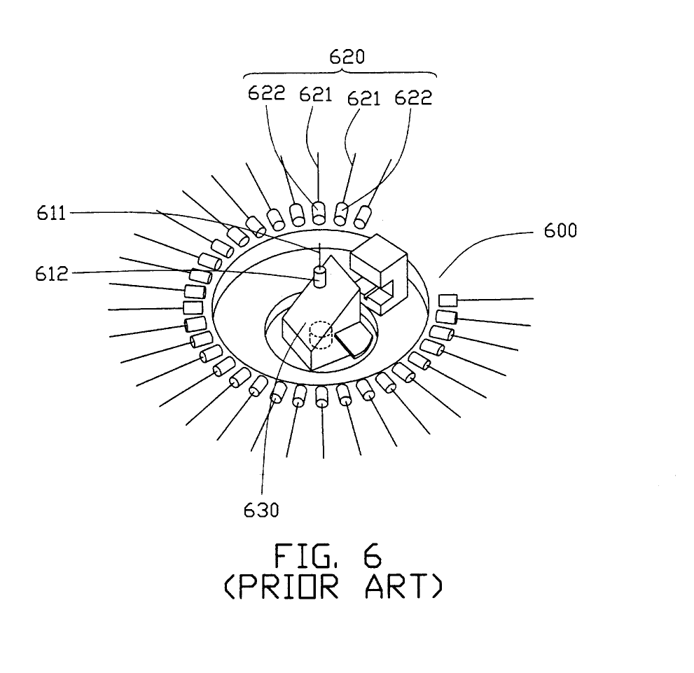

FIG. 4 and FIG. 5 illustrate the operation of the optical switch 10. With the holder 310 in a first position, a first prism 3011 is moved to intersect the optical axis. Input light beams from the input optical fiber 101 are transmitted through the input molded lens 120, are deflected by the prism 3011, and are focused by the output molded lens 220 so that they are directed into the output fiber 2011. With the holder 310 in a second position, a second prism 3012 is moved to intersect the optical axis. The second prism 3012 has a different arrangement of end faces 302 with respect to a plane perpendicular to the optical axis. Thus input light beams from the input optical fiber 101 are transmitted through the input molded lens 120, are deflected by the prism 3012, and are focused by the output molded lens 220, it is collimated into the output fiber 2012.

Advantages of the optical switch 10 of the present invention over those of the prior art include the following. First, only optical components of the switch move; no fibers move. Second, the input and output collimators are easily aligned with one another. Third, using one ferrule to accommodate a plurality of output optical fibers decreases the size and lessens the cost of the optical switch 10 in relation to that of the prior art design, which has relatively widely separated output optical fibers and a plurality of GRIN lenses. Thus, the cost and the size of the design of the present invention are minimized.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An optical switch for switching light beams from one input optical fiber between a plurality of output optical fibers, comprising:
a first collimator aligning with the input optical fiber and collimating input light beams;
a second collimator aligning with the output fibers and collimating output light beams; and
a switching element between the first and second collimators, said switching element comprising a plurality of optical elements;
wherein, each optical element can be rotated in sequence into an optical path between the input and output optical fibers and can each deflect the light beams from the input optical fiber in a unique direction, thereby, switching the input light beams to different output fibers.

2. The optical switch of claim 1, wherein the first and second collimators include molded lenses with a single index.

3. The optical switch of claim 1, wherein the first and second collimators include GRIN lenses having a varying index.

4. The optical switch of claim 1, wherein the optical elements are prisms, wherein each prism has an angled end face making a different angle with the optical path.

5. The optical switch of claim 1, wherein the switching element further comprises a holder with a plurality of mounting holes for accommodating and fixing the optical elements, therein.

6. The optical switch of claim 1, wherein the optical switch further comprises a driving pole connecting with a driving means.

7. The optical switch of claim 1, wherein the optical switch further comprises two ferrules for respectively containing the input and output fibers and for aiding alignment of the input and output fibers with lenses of the collimators, respectively.

8. The optical switch of claim 1, wherein the optical switch further comprises a base for mounting the first and second collimators, the switching element and the driving pole.

9. An optical switch for switching light beams from one input optical fiber between a plurality of output optical fibers, comprising:
a first collimator aligning with the input optical fiber and collimating input light beams;
a second collimator aligning with the output fibers and collimating output light beams; and
a switching element between the first and second collimators comprising a plurality of optical elements;
wherein, each optical element can be moved into an optical path between the input and output optical fibers, respectively, and can each deflect the light beams from the input optical fiber in a unique direction, thereby, switching the input light beams to different output fibers.

10. An optical switch for switching light beams between one input optical fiber and a plurality of output optical fibers, comprising:
a first collimator for aligning with the input optical fiber and collimating an input light beam;
a second collimator for aligning the output optical fibers and collimating output light beams;
a rotatable optical element arranged between the first and second collimators, and defining a rotation center with an arc-like array of optical elements with different refractive indexes thereof, respectively, said different optical elements respectively and mutually exclusively being rotatably moved to a specific position where each of said optical elements receives signals of said single input light beam while transmits said signals to only corresponding one of said output optical fibers to result in only corresponding one of said output light beams; wherein
the rotation center is laterally far away from axes of said first and second collimators.
